(19) United States
(12) Patent Application Publication
(10) Pub. No.: US 2009/0100909 A1
(43) Pub. Date: Apr. 23, 2009

(54) Leak testing method and leak testing device

(75) Inventors: Werner Grosse Bley, Bonn (DE); Daniel Wetzig, Cologne (DE)

Correspondence Address: MARJAMA MULDOON BLASIAK & SULLIVAN LLP, 250 SOUTH CLINTON STREET, SUITE 300, SYRACUSE, NY, 13202, US

(73) Assignee: Inficon Gmbh, Koln (DE)

(21) Appl. No.: 11/663,391

(22) PCT Filed: Sep. 19, 2005
(86) PCT No.: PCT/EP05/54110

§ 371 Date: Apr. 30, 2008

(30) Foreign Application Priority Data
Sep. 22, 2004 (DE) 10 2004 046 617.3

(51) Int. Cl. G01M 3/04

(52) U.S. Cl. 73/40.7

(57) ABSTRACT

A leak testing device includes a chamber which is hermetically sealed towards the environment, having a test object filled with a test gas that is positioned in the chamber. In the chamber, a partial-pressure sensor is arranged that selectively responds to the test gas, but not to the filler gas. Thus, a leak test can be simply performed without high vacuum and without mass spectrometers.

### FIELD OF THE INVENTION

The invention relates to a leak testing method where a hollow test object filled with a test gas is placed into a chamber, wherein the test gas leaking from the test object is detected by a gas sensor.

### BACKGROUND OF THE INVENTION

The European Standard DIN EN 13185 “Dichtheitsprüfung” [leak test] describes various leak testing methods. Among these are group B methods: a test gas flow from the test object. The B.3 method is an overpressure method with accumulation. The test object filled with a pressurized test gas is arranged in a gastight envelope. After a given period, the accumulated test gas is measured with a leak detector, which is connected with the envelope. The magnitude of the leak can then be estimated or determined if volume and pressure of the envelope are known. The B.6 method is a vacuum method. Small objects filled with a test gas are placed into a chamber. The chamber is then evacuated until a pressure is reached which lies below the internal pressure of the test object. The leak detector is connected with the vacuum chamber. The overall test gas flow from the test object is measured with the leak detector. This European Standard and the methods defined therein are elucidated in the article “Neue Norm zur Auswahl eines geeigneten Verfahrens zur Lecksuche und Dichtheitsprüfung” [new standard for selecting a suitable method for leak detection and leak testing] by Gerhard Schröder in ZfP—Zeitung 74, Apr. 2001, pages 31-39. The B.3 and B.6 methods require a high vacuum to be generated in the envelope of the test object for making the leak detector, which comprises a mass spectrometer, operative. A mass spectrometer requires generation of a high vacuum, wherein complex pumps, such as turbomolecular pumps and friction molecular pumps, are necessary for this purpose. Although such leak detection means are highly sensitive, they require a very large vacuum-technical expenditure.

In the overpressure method, the leak rate q_{G} of the test object is calculated according to the following equation:

$${q}_{G} = p \cdot \frac{V \cdot ( {c}_{1} - {c}_{0} )}{( {t}_{1} - {t}_{0} )}$$

where:
q_{G} is the overall leak rate in Pascal cubic meters per second;
p,V are pressure and volume in Pascal cubic meters of the additional envelope;
c0,c1 are the volume concentrations at times t1 and t2 at the beginning and the end of the measurement in the additional envelope; and
t0,t1 are the times of the beginning and the end of the measurement.

Here, it is necessary to know the total pressure p in the envelope (chamber) since the concentration c is measured. Only the product of total pressure and concentration results in the partial pressure p* of the test gas (p•c=p*). Further, the total pressure must be kept constant, since otherwise the calculated partial pressure is not proportional to the leak rate.

The journal “ZfP—In Anwendung, Entwicklung und Forschung” [nondestructive testing—in application, development and research] includes an article titled “Laseroptische Messverfahren zur Dichtheitsprüfung mit Leckortung” [laser-optical measuring methods for leak testing with leak detection], concerning a contribution by Schroff and Stetter at the annual conference of the DGZfP [German association of nondestructive testing] 2001 in Berlin. Gas is extracted from the chamber in which the test object is arranged, and passed to a detection chamber. The chamber contains air as a filler gas, and the test object contains sulfur hexafluoride (SF₆) as a test gas, which selectively absorbs the radiation of a CO₂ waveguide laser. The laser beam passes through the gas contained in the detection chamber, and the absorption of the laser beam is measured. Such a method requires a complex detection chamber and laser apparatus. The detection chamber is connected with a vacuum pump.

In DE 100 31 882 A1 (Leybold Vakuum GmbH) a partial-pressure sensor for helium or hydrogen is described, the sensor comprising a chamber closed by a membrane of a silicon material with the desired selective permeability characteristics. The sensor chamber contains a Penning pressure sensor made up of cathode plates between which an anode ring is arranged. A permanent magnet generates the magnetic field required for the Penning discharge. A Penning pressure sensor supplies a total pressure value on the basis of the current flowing between the cathode plates and the anode ring. The membrane allows only certain gases, such as helium or hydrogen, to enter into the sensor chamber. A similar description of a partial-pressure sensor is included in the patent application DE10 2004 034 381 (not published), the contents of which is hereby incorporated by reference.

### SUMMARY OF THE INVENTION

It is an object of the invention to provide a leak testing method and a corresponding leak testing device which allow a leak test to be performed in a simple manner without generation of a high vacuum.

According to a first variant of the leak testing method according to the invention, a chamber is hermetically sealed such that a constant filler gas volume is produced in the chamber. A partial-pressure sensor is used as a gas sensor, whose membrane is arranged in the chamber. In this method, no gas is extracted from the chamber, i.e., neither filler gas nor any test gas contained therein. The gas volume in the chamber remains in the hermetically sealed chamber and is not extracted for testing or measuring purposes. An essential advantage of the leak testing method is that the leak test can be performed at any pressure, such as atmospheric pressure or a slight negative pressure or a time-variable pressure. In any case, generation of a vacuum is not necessary. Vacuum within the meaning of this description generally relates to a pressure of less than 1 mbar, although the pressure required for operating a mass spectrometer is much lower (10⁻⁴ mbar).

Air can be used as a filler gas for the chamber. The chamber must then only be tightly sealed without being evacuated. Noble gases, in particular helium or hydrogen, can be used as a test gas. Helium and hydrogen offer the advantage that they can be detected and quantified with a relatively simple partial-pressure sensor. Further, helium is particularly suitable since it is a light gas, which escapes even through the finest leaks.

A particular advantage of the first variant of the invention is that no gas transport lines are to be connected with the chamber. Although gas can be drawn off the chamber prior to the start of the partial-pressure measurement, the actual measurement is performed without gas being extracted from the chamber or fed into the chamber.

It is not necessary to calculate the partial pressure p* of the test gas in the chamber on the basis of the overall pressure p and the concentration c according to the equation p*=p•c, since the partial pressure p* is directly measured by the sensor.

According to an embodiment of the invention, the filler gas is circulated in the chamber. Such a circulation is appropriate for the purpose of uniformly distributing the test gas atoms in the filler gas. Filler gas leaking from the test object is prevented from remaining at the surface of the test object.

The leak test is advantageously performed such that the partial pressure of the test gas is measured at the beginning and the end of a measuring period, and the leak rate is determined from the difference. When the absolute value of the leak rate is determined, the chamber volume V is taken into account.

According to the invention, the chamber can also be provided with a bypass line, which includes a fan and draws in the gas at one location of the chamber and returns the gas to the chamber at another location for the purpose of effecting the required ventilation in the chamber. In this case, the volume of the bypass line forms part of the chamber volume.

The invention further relates to a leak testing device for performing the first variant of the method according to the invention. This leak testing device is characterized in that the membrane of a partial-pressure sensor is arranged in the chamber, which partial-pressure sensor responds to the test gas but not to the filler gas.

The chamber may comprise an fan device which, relative to the test object, is arranged opposite the partial-pressure sensor. The partial-pressure sensor may be disposed in or at a wall of the chamber.

According to a second variant of the inventive method, a filler gas passes through the chamber, and at a filler gas outlet of the chamber, or immediately behind said outlet, a partial-pressure sensor is positioned. Here, too, the filler gas preferably is air. The gas continuously flows through the chamber, wherein the partial pressure of the test gas is measured at the outlet. In this manner, the presence of test gas in the filler gas is determined, and a precise measure of the size and the overall leak rate of the test object is obtained. A calibration using a test object with a known leak rate is possible.

In the second variant, a pressure is preferably maintained in the chamber, which is lower than the atmospheric pressure but higher than 1 mbar such that the generated filler gas flow forms a non-molecular flow. The filler gas flow is to effect a uniform distribution of the test gas introduced into the chamber. It acts as a carrier gas via which the escaped test gas is fed to the partial-pressure sensor. Preferably, the flow is turbulent. In any case, the flow is a viscous gas flow as compared to a molecular flow, which is produced by high-vacuum pumps in a high vacuum, to which the laws of viscous gas flows do not apply.

A leak testing device according to the second variant of the invention comprises a chamber having a gas inlet and a gas outlet. At the gas outlet, or immediately behind said outlet, a partial-pressure sensor is arranged. The gas outlet may be connected with a suction fan, which effects the required flow through the chamber for the purpose of entraining test gas leaked from the test object. Such a suction fan may be configured like a normal fan. It merely serves for generating a gas flow and not for generating a defined vacuum. The gas flow may also be generated by applying an overpressure (without a suction fan).

It is not necessary to control the gas flow, since the partial pressure of the test gas is measured. A change of the gas flow merely results in a change of the total pressure, which does not influence the measurement of the test gas partial pressure.

### BRIEF DESCRIPTION OF THE DRAWINGS

Embodiments of the invention will now be described in greater detail with reference to the drawings, in which:

FIG. 1 shows a schematic representation of a leak testing device according to a first variant of the invention,

FIG. 2 shows a modified detail of FIG. 1 with a partial-pressure sensor arranged in the chamber wall, and

FIG. 3 shows a schematic representation of a leak testing device according to a second variant of the invention.

### DETAILED DESCRIPTION

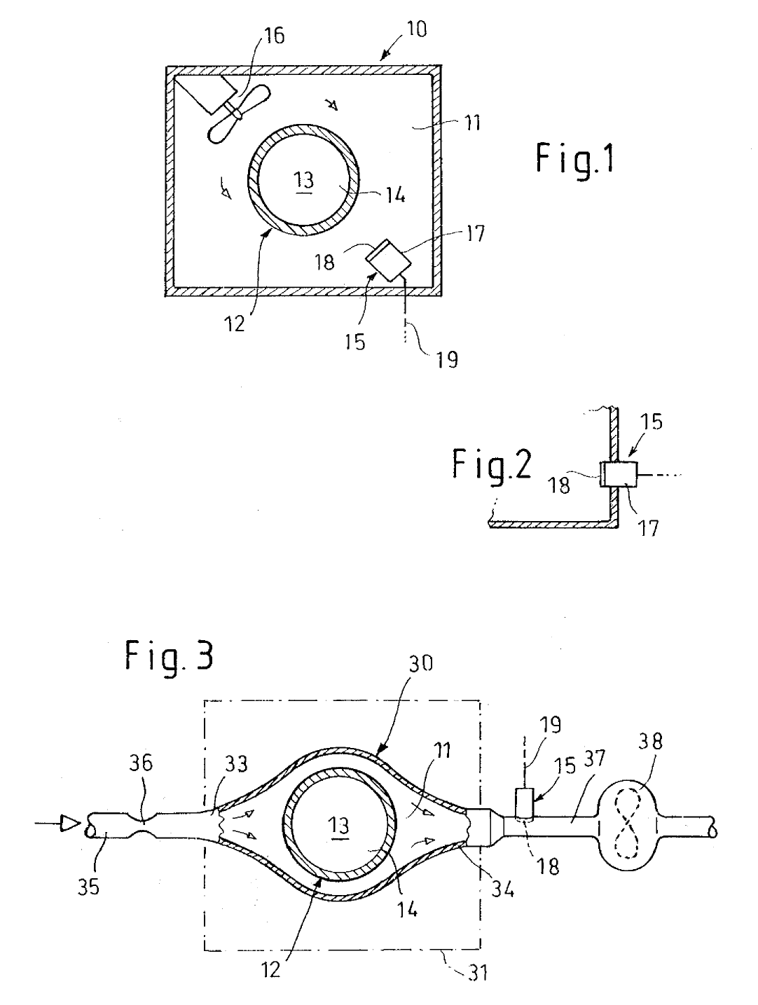

According to FIG. 1, a filler gas 11 is contained in a chamber 10 which is hermetically sealed towards the atmosphere. Normally, air is used as the filler gas 11. The chamber 10 may comprise a detachable cover which offers access to the chamber and which tightly closes the chamber when the test object has been placed therein. In the chamber 10, the same pressure may prevail as in the environment; however, it is also possible to reduce the pressure in the chamber, but not below 1 mbar, since in this case, gas ventilation in the chamber would no longer be possible.

A test object 12 is arranged in the chamber 10. The test object 12 is a hollow body whose cavity 13 is filled with a test gas 14, for example, helium. When the test object 12 has a leak, helium enters into the chamber 10. Leaking test gas is detected by the gas sensor 15. The leak rate, i.e., the flow rate of test gas leaking per time unit, can also be determined.

The chamber 10 includes a fan device 16 driving the filler gas 11 and generating a gas flow which is directed to the test object 12 and sweeps along the test object 12. On the opposite side of the chamber 10, the gas sensor 15 is arranged. This gas sensor 15 is a partial-pressure sensor, which selectively responds to the presence of test gas 14, but not to the filler gas 11. The gas sensor 15 is described in detail in DE 100 31 882 A1 and in DE 10 2004 034 381. It comprises a gas-tight housing 17, which is of a cup-shaped configuration and which is closed by a membrane 18 at a front side thereof. The housing 17 is normally made of glass, and the membrane 18 is made of a semiconductor material, in particular silicon oxide. At the membrane 18, a plurality of heating coils are provided which are connected with a current source for heating the membrane. The membrane 18 is connected with the housing 17 made of the same base material such that the interior of the housing is tightly sealed. The membrane 18 is selectively permeable to individual gases, such as helium or hydrogen. In the housing 17, a Penning pressure sensor is arranged for measuring the overall gas pressure in the housing 17. Since only test gas 14 can enter into the housing 17 via the membrane 18, the measured gas pressure corresponds to the partial pressure of the test gas. At a line 19, an electric signal is issued which corresponds to the partial pressure.

The described device 10 is suitable for detecting the presence of a leak at the test object 12. Further, the leak rate Q can be detected. For this purpose, the change of the partial pressure p within a measuring period tₚ is determined. The leak rate is defined by the following equation:

$$Q = V \cdot \frac{{Δ}_{{p}^{*}}}{{t}_{p}}$$

Here, Δ_{p*} is the increase (change) of the partial pressure p* within the measuring period tₚ, and V is the volume of the chamber 10.

While in FIG. 1 the gas sensor 15 is arranged inside the chamber 10, FIG. 2 shows an embodiment where the gas sensor 15 is integrated in the wall of the chamber, wherein the membrane 18 is exposed towards the interior of the chamber.

FIG. 3 shows an embodiment of the second variant of the invention. Here, a chamber 30 is provided which is essentially adapted to the shape and size of the test object 12 such that a gas flowing through the chamber sweeps closely along the test object 12. The chamber 30 is attached to a frame 31 which supports the chamber and allows the chamber to assume various shapes.

The chamber 30 comprises at one end, a filler gas inlet 33 and at the opposite end, a filler gas outlet 34. The filler gas is fed to the filler gas inlet 33 via a supply line 35 which comprises a permanent constriction 36. The filler gas outlet 34 is connected with a discharge line 37 which comprises a suction fan 38.

The suction fan 38 feeds a continuous flow of ambient air through the chamber 30. The constriction 36 generates a slight negative pressure in the chamber 30. The negative pressure need not be kept constant and thus need not be controlled.

At the filler gas outlet 34, or immediately behind said outlet, a gas sensor 15 is arranged whose membrane 18 is located in the gas line. The gas sensor 15 is a partial-pressure sensor, as described with reference to FIG. 1.

The leak testing device shown in FIG. 3 operates as follows:

The test object 12 filled with the test gas 14 is placed into the chamber 30 which is then closed. Subsequently, the suction fan 38 is switched on such that ambient air as a filler gas is drawn into the supply line 35 and flows through the chamber 30. If the test object 12 has a leak, the filler gas takes up the test gas 14. The presence of test gas 14 is detected by the gas sensor 15 which is a partial-pressure sensor.

In the embodiment shown in FIG. 3, the air flow is fed through the chamber 30 by the suction fan 38. Alternatively, it is possible to use, instead of a suction fan, a fan arranged upstream of the chamber 30. A constriction is then located downstream of the chamber.

The invention offers a simple and inexpensive leak testing method which is in particular suitable for testing industrially produced test objects, i.e. for both individual testing and mass testing.

We claim:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A leak testing method, said method comprising the steps of:
filling a hollow test object with a test gas;
placing said hollow test object into a chamber that initially contains a test gas-free filling gas atmosphere; and
detecting the leakage of test gas from the test object using a gas sensor, said sensor being responsive to the test gas but not to the filler gas, wherein the chamber is hermetically sealed such that a constant filler gas volume is produced, and that a partial-pressure sensor comprising a membrane selectively permeable to the test gas is used as said gas sensor, said membrane being arranged in the chamber.

16. The leak testing method according to claim 15, wherein the filler gas is circulated in the chamber.

17. The leak testing method according to claim 15, wherein the filler gas in the chamber is driven such that a flow sweeping along the test object is produced that detaches test gas molecules from the test object.

18. The leak testing method according to claim 15, wherein the gas sensor is arranged in a wall of the chamber.

19. The leak testing method according to claim 15, wherein the partial pressure of the test gas is measured at the beginning and the end of a measuring period (tₚ), and the leak rate Q is determined from the difference.

20. A leak testing device comprising a chamber adapted to be filled with a filler gas and to be hermetically sealed, said chamber accepting a test object filled with the test gas, said device further including a partial-pressure sensor having a membrane, said membrane being arranged in the chamber such that said membrane responds to the test gas, but not to the filler gas.

21. The leak testing device according to claim 20, wherein the chamber comprises a fan device which, relative to the test object, is arranged opposite the partial-pressure sensor.

22. The leak testing device according to claim 20, wherein the partial-pressure sensor is arranged in or at a wall of the chamber.

23. A leak testing method, said method comprising the steps of:
filling a hollow test object with a test gas;
placing said hollow test object into a chamber that initially contains a test gas-free filling gas atmosphere; and
detecting the leakage of test gas from the test object using a gas sensor, wherein the filler gas passes through the chamber, and that at a filler gas outlet of the chamber, or immediately behind said outlet, a partial-pressure sensor is positioned which comprises a membrane that is selectively permeable to the test gas.

24. The leak testing method according to claim 23, wherein a pressure is maintained in the chamber that is lower than the atmospheric pressure, but higher than 1 mbar, such that the generated filler gas flow forms a non-molecular flow.

25. A leak testing device comprising:
a chamber that accepts a test object filled with a test gas;
a filler gas inlet;
a filler gas outlet; and
a partial-pressure sensor is arranged at or immediately behind said filler gas outlet.

26. The leak testing device according to claim 25, wherein the filler gas outlet is connected with a suction fan.

27. The leak testing device according to claim 25, wherein the filler gas inlet is provided with a constriction.

28. The leak testing device according to claim 25, wherein the filler gas inlet is connected with a pressure generator.
